(19) United States
(12) Patent Application Publication
(10) Pub. No.: US 2003/0235183 A1
(43) Pub. Date: Dec. 25, 2003

(54) Packetized voice system and method

(75) Inventors: Jeffrey S. Skelton, Perrineville, NJ (US); William Shankle, Jackson, NJ (US)

Correspondence Address: OBLON, SPIVAK, MCCLELLAND, MAIER & NEUSTADT, P.C., 1940 DUKE STREET, ALEXANDRIA, VA, 22314, US

(73) Assignee: Net2Phone, Inc., Newark, NJ

(21) Appl. No.: 10/175,879

(22) Filed: Jun. 21, 2002

(51) Int. Cl. H04L 12/66

(52) U.S. Cl. 370/352

(57) ABSTRACT

A method and system of performing call processing in a packet voice environment, and in one particular embodiment to a packet voice environment for providing enhanced services (e.g., voice conferencing, dictation services, and voice mail). By controlling multiple, independent inbound and outbound voice streams, enhanced services can be distributed and load balanced.

### BACKGROUND OF THE INVENTION

1. Field of the Invention

The present invention is directed to a method and system of performing call processing in a packet voice environment, and in one particular embodiment to a packet voice environment for providing enhanced services (e.g., voice conferencing, dictation services, and voice mail).

2. Discussion of the Background

Telephone companies (sometimes referred to as “Telcos”) have been known to provide a number of enhanced services. Circuit switched-based voice applications typically require an Interactive Voice Response (IVR) farm of equipment (e.g., implemented as a Telco Switch or PBX or as numerous IVR Servers). In such environments, IVR Server Application development is often done with tools provided by the IVR vendor to work with their proprietary application system. Also, content is usually limited to a single application in a single domain. That is, traditional Tele IVR solutions are dedicated to only a single IVR system. Outbound Services also consume limited line resources in a circuit switched environment.

### SUMMARY OF THE INVENTION

It is an object of the present invention to provide at least one telephone service built on top of a packet voice network. Such services include, but are not limited to, Text-to-Speech engines, Voice Recording/Voice Mail engines, Pre-Recorded Prompt Servers and Automatic Speech Recognition engines. By providing these components separately and independently, a number of services can be provided to a single user from different computers or switches within the same telephone call. The separate routing of incoming and outgoing services enables the greatest flexibility in implementing the speech platform.

It is another object of the present invention to provide personalized services to end users. Such personalized services can enable customized services (e.g., prompts or levels of service) to be provided based on call information (e.g., ANI, ANI2, DNIS, or unique identifiers).

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram of a general system architecture of the present invention;

FIG. 2 is a general block diagram of an illustrative network for providing distributed voice services according to the present invention;

FIGS. 3a-3d are call flow control diagrams for providing inbound call setup control services according to the present invention;

FIG. 3e is a ladder diagram showing a condensed version of the steps of FIGS. 3a-3d;

FIGS. 4a-4c are call flow control diagrams for providing DTMF tone detection services according to the present invention;

FIG. 4d is a ladder diagram showing a condensed version of the steps of FIGS. 4a-4c;

FIGS. 5a-5c are call flow control diagrams for providing generated speech services according to the present invention;

FIG. 5d is a ladder diagram showing a condensed version of the steps of FIGS. 5a-5c;

FIGS. 6a-6c are call flow control diagrams for providing automated speech recognition services according to the present invention;

FIG. 6d is a ladder diagram showing a condensed version of the steps of FIGS. 6a-6c;

FIGS. 7a-7c are call flow control diagrams for providing speech recording services according to the present invention;

FIG. 7d is a ladder diagram showing a condensed version of the steps of FIGS. 7a-7c;

FIGS. 8a-8b are call flow control diagrams for providing file disposition services according to the present invention;

FIG. 8c is a ladder diagram showing a condensed version of the steps of FIGS. 8a-8c;

FIGS. 9a-9c are call flow control diagrams for providing outbound call setup services according to the present invention;

FIG. 9d is a ladder diagram showing a condensed version of the steps of FIGS. 9a-9c;

FIG. 10a is a call flow control diagram for providing inbound call leg termination services according to the present invention;

FIG. 10b is a ladder diagram showing the steps of FIG. 10a;

FIG. 11a is a call flow control diagram for providing outbound call leg termination services according to the present invention;

FIG. 11b is a ladder diagram showing the steps of FIG. 11a;

FIG. 12a is a call flow control diagram for providing application termination services according to the present invention;

FIG. 12b is a ladder diagram showing the steps of FIG. 12a;

FIG. 13 is a schematic illustration of a computer for providing at least one of the media services according to the present invention;

FIG. 14 is a block diagram of a single telephony device utilizing the services of two different servers simultaneously;

FIG. 15 is a block diagram of a multiples telephones being connected to a single gateway but to different servers, even though both telephones are utilizing the same services; and

FIG. 16 is a block diagram of a voicemail application implemented as a cooperating series of media services.

### DETAILED DESCRIPTION OF THE PREFERED EMBODIMENTS

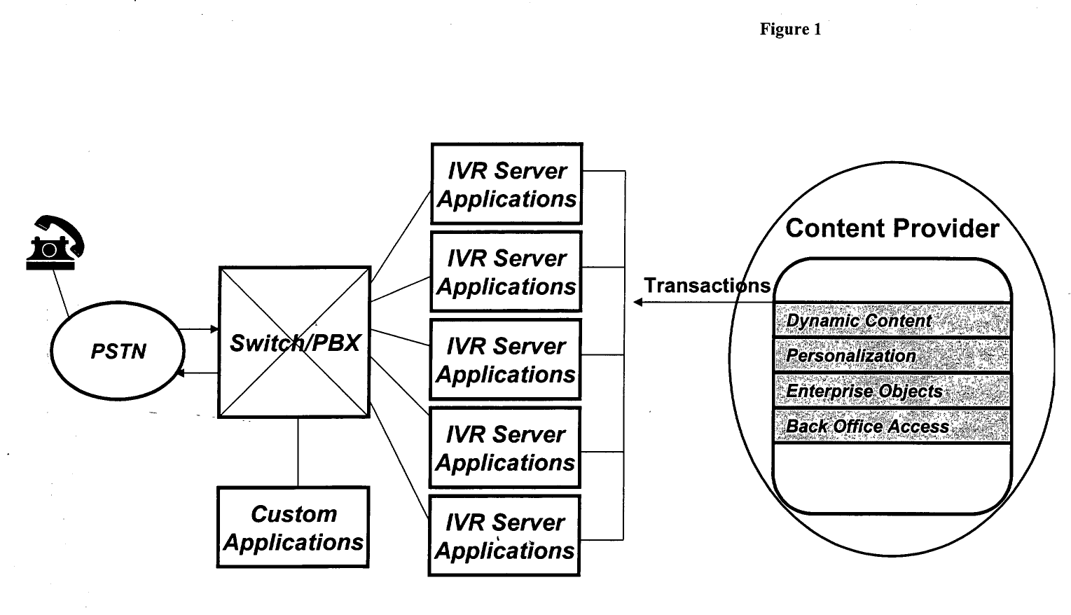

Referring now to the drawings, wherein like reference numerals designate identical or corresponding parts throughout the several views, FIG. 1 illustrates the functional capability of the present invention to support scalability, dynamic content and personalization of services allowing value-added applications to be built and run in a packet switched voice network.

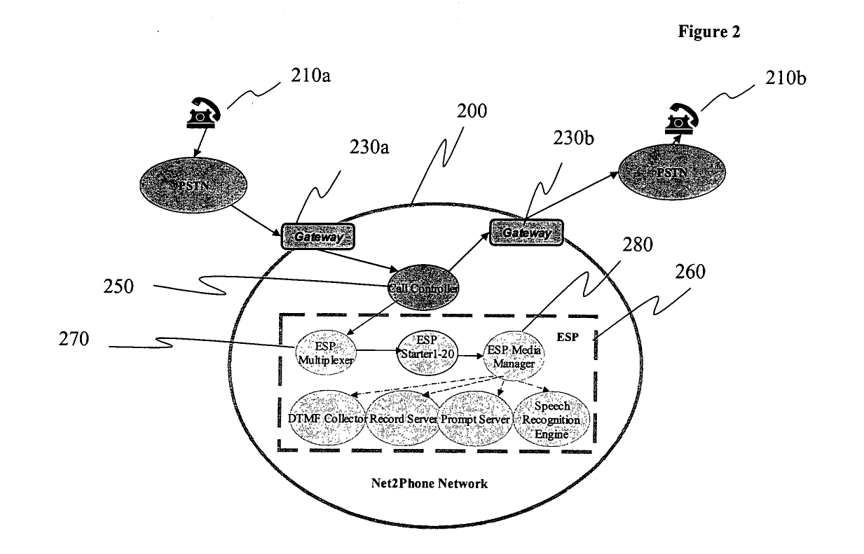

FIG. 2 is a first embodiment of a switch network 200. A user connects to the switch network 200 via a gateway (e.g., 230a or 230b) using any one of (1) a standard phone (e.g., 210a or 210b) through the Public Switched Telephone Network (PSTN), (2) an Internet phone and (3) a PC running Internet telephony software. Gateways can include, but are not limited to, (1) PCs equipped with telephony cards (e.g., telephony cards made by Dialogic), (2) Nuera GX21s and GX8s, and (3) Cisco 5300s.

Such a switch network 200 generally includes a call controller 250 and at least one platform 260 that is controlled by software. Such a platform 260 will be referred to herein as a “Enhanced Services Platform” (“ESP”) or a “SoftSwitch” (as the software switches between types of call control) and may be utilized as an application platform for running Voice over IP (VoIP)-enabled and telephony-enabled applications. As illustrated in FIG. 2, the ESP 260 can include several media services (e.g., a touch tone (DTMF) collector, a record server, a prompt server and a speech recognition server) simultaneously.

As would be appreciated by one of ordinary skill in the art, one advantage of such a network is that voice and other services provided by the ESP 260 can scale as the number of packet-based calling services increase. Moreover, the voice and other services can be split into directional services (i.e., services for inbound versus outbound calls). For example, the user on the phone can be listening to a Text-to-Speech Server (being provided as an outbound service) but talking to a Speech Recognition Server (being provided as an inbound service). The splitting of services into directional parts also allows the ESP media servers to be load balanced across multiple machines and applications.

Access to the services of the ESP 260 may be made available through standard Application Programming Interfaces (APIs). For example, an object oriented Java API may expose Telephony and Account capabilities while a VoiceXML API exposes speech-enabled Interactive Voice Response capabilities. The ESP 260 enables services to be built on Text-to-Speech engines, Voice Recording/Voice Mail engines, Pre-Recorded Prompt Server, Conference Bridges and Automatic Speech Recognition engines within the ESP environment.

Another such service is Voice browsing (e.g., using VXML). The switch system of the present invention can interact with remote servers (e.g., web application servers) that are controlled by such voice extensions and that access data in a number of formats (e.g., XML and enterprise data). In light of the packet-based routing, the content can be centrally stored while the call processing can be performed in a distributed fashion. Moreover, since the switch is connected to dynamically generated content, an almost limitless number of real-time services (e.g., stock quotes, voicemail retrieval, message broadcast, and pager services) can be provided using the same switch control architecture.

In general, ESP provides centralized support for enhanced telephone voice services within a packet-switched (e.g., voice-over-IP) network. Enhanced telephone services include call control, interactive voice response (IVR) for service determination and account validation and media services such as voice recording/email services, pre-recorded prompt servers, text-to-speech engines and automatic speech recognition engines.

The ESP platform 260 is a set of software modules which interact (via messages and programming callbacks) with IP network switches to provide these services. While call processing is distributed across the network, content such as pre-recorded prompts or voice recognition grammar can be stored centrally and made available to multiple applications at the same time.

In one embodiment, applications use capabilities of the ESP 260 through a Java API which exposes call control and media services through a set of Java objects. ESP's JTAPI implementation provides call control to applications and the underlying ESP media service API provides applications with access to ESP media services.

ESP processes communicate with Call Controller 250 and Gateways 230 via messages. Control messages inform the appropriate process of the state of a call and direct the appropriate process to perform specific actions. When a call arrives at a gateway (e.g., 230a or 230b), the call controller 250 is informed. The call controller 250 sends a message to the ESP multiplexer 270 to start an ESP application.

ESP Starters are the processes which run ESP applications. An ESP starter can simultaneously run multiple ESP applications. The ESP Multiplexer 270 is responsible for load balancing across the ESP starters and for selecting an ESP Starter based on the system load of all the starters.

ESP applications request media services through the ESP Media Manager 280. Status messages between all media services inform the media manager of their maximum capacity and current utilization. The media manager keeps track of this information on all media services of a specific type and performs a combination percentage utilization load balancing and/or location-based load balancing in its selection of a requested media service. There are times when it is important to select a media server that is “close” (with respect to the IP network) to the Gateway that the media server will be exchanging voice IP packets with. Alternatively, round robin allocations can be used as well. An ESP application then makes requests directly to the media service when a service is needed. ESP call control objects maintain the IP address/port information that allow the media services to send and receive voice streams for a call.

To facilitate a better understanding of the operation of and the interaction of the components of the network 200, a series of examples are provided below.

Those examples include: (1) Inbound Call Setup, (2) Collecting DTMF Tones, (3) Playing Prompts and Text-to-Speech, (4) Automatic Speech Recognition, (5) Recording Voice, (6) Disposing of a Voice Recording, (7) Outbound Call Setup, (8), and (9) Call Termination.

These examples illustrate how the ESP platform provides call control to applications and how ESP media services are accessed by applications. Each example includes functional descriptions of a set of messages with reference to at least one of the figures that depict(s) the process interactions which take place.

### EXAMPLE 1

### Inbound Call Setup

This example describes the message sequencing that takes place to start an ESP application and provide media services to that application. At the end of this message sequence, an application has access to an inbound call's voice stream and is capable of using any of the ESP media services it needs.

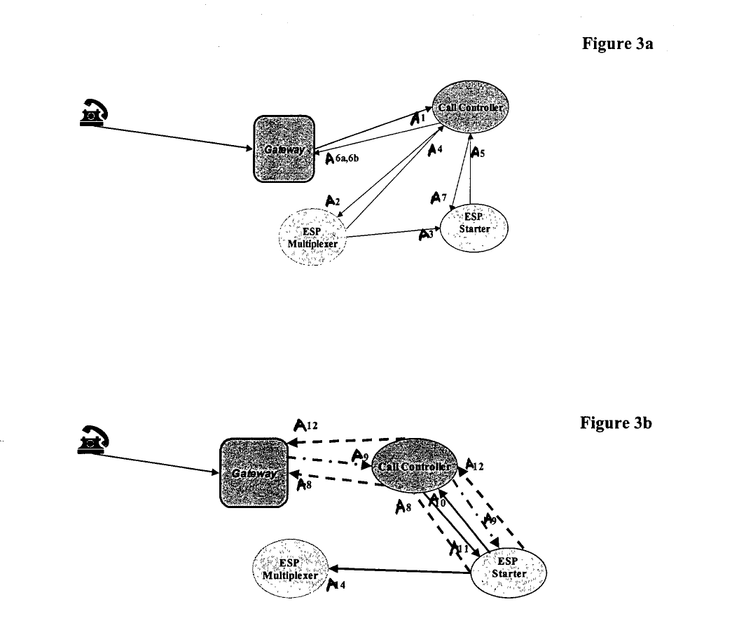

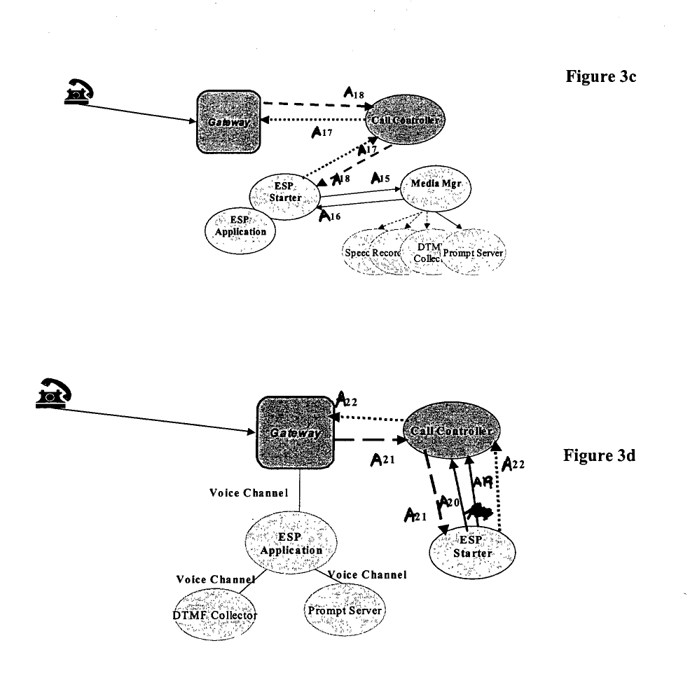

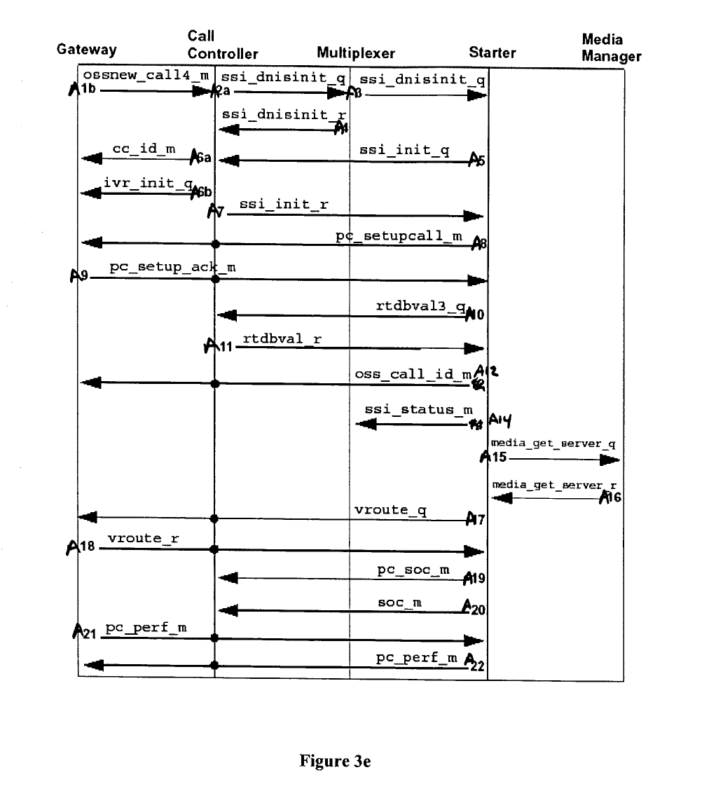

Referring now to FIG. 3a, the first phase of the inbound call setup is performed. Generally, when a call arrives at a corresponding gateway (e.g., 230a or 230b) the call controller 250 is notified. The call controller 250 performs a lookup in the platform database to determine which application should be invoked. It informs the ESP multiplexer of the call and the application to associate with the call. The multiplexer selects an ESP starter (e.g., using a least busy algorithm) and passes the call information to it. ESP then sets up the voice channels for the application. To achieve this, illustratively steps A1-A7 of the inbound call setup are performed as follows:

A1. Gateway 230a performs a database lookup based on the dialed number to identify which application should be run. When an application is found, the Gateway notifies the Call Controller 250 that the application should be started via the oss_newcall4_m message.

A2. The Call Controller 250 notifies the ESP Multiplexer 270 to start the Application via the ssi_dnisinit_q message.

A3. The ESP Multiplexer selects the least busy ESP Starter and forwards the call via the ssi_dnisinit_q message.

A4. The ESP Multiplexer informs Call Controller 250 that it forwarded the call via the ssi_dnisinit_r message.

A5. The ESP Starter informs the Call Controller 250 that it has the call via the ssi_init_q message.

A6. The Call Controller 250 instructs the Gateway 230a to go stable on the call via the cc_id_m and the ivr_init_q messages.

A7. The Call Controller 250 acknowledges the ESP Starter via the ssi_init_r message.

The second phase of the setup process is described with reference to FIG. 3b. The starter process establishes communication with the gateway and negotiates call setup parameters with it (e.g. codec type, protocol to use). The starter process requests an internal call id from the call controller, associates the call id with the voice channel and sends the gateway this information. The call is now setup for control by an ESP application. To achieve this, illustratively steps A8-A14 of the inbound call setup are performed as follows:

A8. Starter requests call setup flags from Gateway via Call Controller via the pc_setupcall_m message.

A9. Gateway returns call setup flags to Starter via Call Controller via the pc_setup_ack_m message.

A10. Starter requests a Call ID from the Call Controller via the rtdbval3_q message.

A11. Call Controller requests the ID from the database and returns it to the Starter via the rtdbval_r message.

A12. Starter informs Gateway via the Call Controller that the current Call ID and channel are associated via the oss_call_id_m message.

A13. Starter determines the CF Application with which the dialed number is associated and starts it on its own separate thread.

A14. Starter informs the ESP Multiplexer of its status via the ssi_starter_status_m message.

With reference to FIG. 3c, the ESP Application/Media Service is then started. The starter process starts the ESP application in a separate thread. The starter queries the application to determine which media services are needed on the call and requests those services from the media manager. The starter process notifies both the gateway and the media services of the call routing information needed to access the voice channels for the call. The ESP application is now able to control the call and to request media services such as playing prompts or collecting DTMF tones generated by the caller. To achieve this, illustratively steps A15-A18 of the inbound call setup are performed as follows:

A15. Call Flow Application requests services from the Media Manager 280 via the media_get_server_q message.

A16. Media Manager grants services to the CF Application via the media_get_server_r message.

A17. CF Application notifies the Gateway via the Call Controller where to listen and where to speak via the vroute_q message.

A18. Gateway acknowledges the message from the Call Flow Application via the Call Controller via the vroute_r message.

Lastly, with reference to FIG. 3d, the application is then running after step A18. The starter process notifies the gateway and the call controller that the call has started. The call controller updates the billing information with the start of call time. The gateway and starter process use ‘keep alive’ messages to ensure the communication paths are up and running between the gateway and ESP. To achieve this, illustratively steps A19-A22 of the inbound call setup are performed as follows:

A19. The ESP Starter informs the Gateway that the call has started via the pc_soc_m message.

A20. Starter notifies the Call Controller to update the Call Detail Record with the correct call start time via the message soc_m.

A21. The Gateway broadcasts a “keep alive” message to the ESP Starter via the message pc_perf_m.

A22. The ESP Starter acknowledges the keep alive message via the message pc_perf_m.

The entirety of steps A1-A22 can also be seen in ladder diagram form in FIG. 3e.

### EXAMPLE 2

### Collecting DTMF Tones

Many applications need to detect (e.g., in order to obtain account information) when a caller has (1) pushed buttons on the standard telephone (e.g., 210a or 210b), (2) pushed buttons on an Internet telephone, or (3) clicked on telephony software on a PC. ESP 260 supports this capability through the DTMF Collector service. This example describes how DTMF tones generated by a caller are detected by the DTMF Collector service and made available to an ESP application.

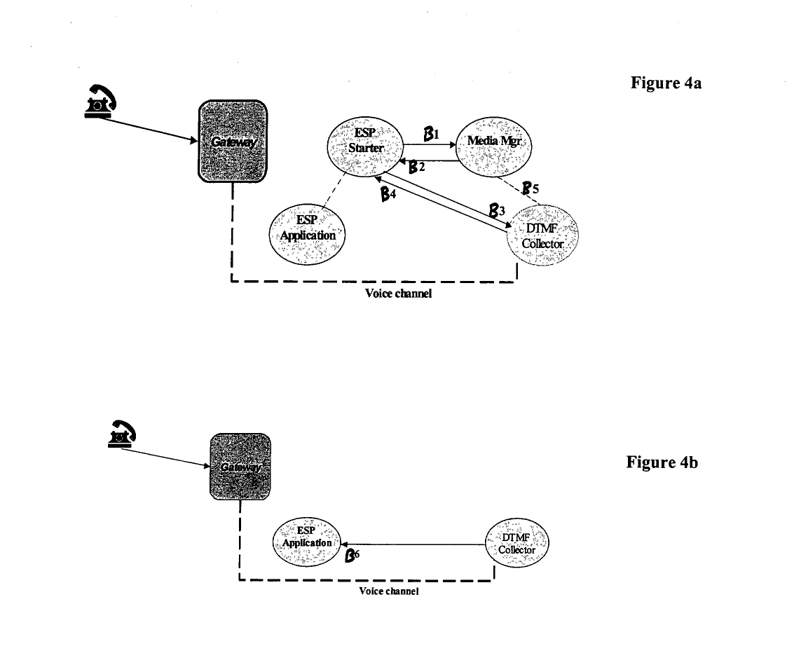

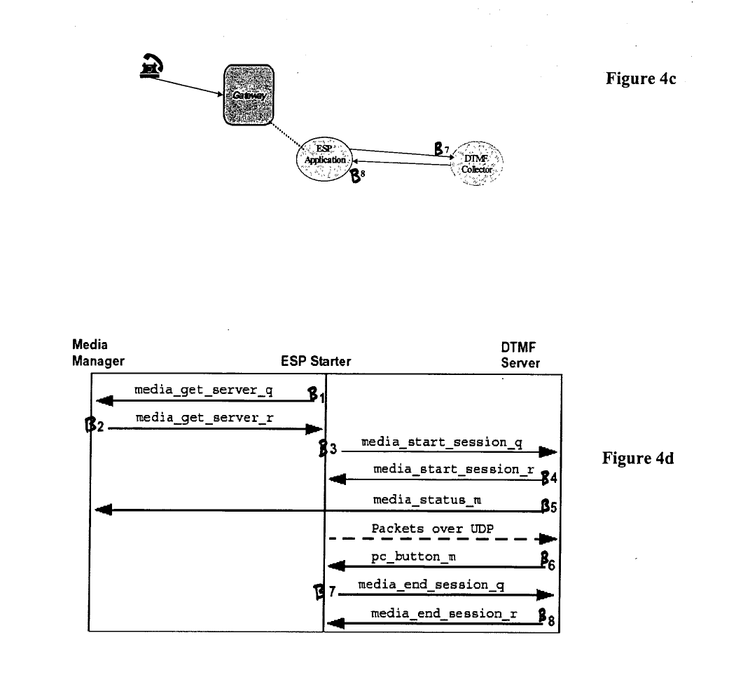

With reference to FIG. 4a, an ESP Starter sends a message to the Media Manager 280 requesting access to a DTMF Collector on behalf of an ESP application that has requested this service. An application can request this service at startup (as described in the example above) or during the course of the application flow. The ESP Starter notifies the DTMF collector to begin collecting DTMF tones. The collector uses the IP address/port information provided in the message to establish a voice channel with the gateway. The DTMF collector is now ready to detect DTMF tones on the voice channel. The Media Manager 280 process keeps track of the status and availability of the DTMF Collector service through status messages sent to it by the Collector (message B5). To achieve this, illustratively steps B1-B5 of a tone collecting method are performed as follows:

B1. The ESP Starter requests a DTMF Collector media service from the Media Manager via the message media_get_server_q.

B2. The Media Manager returns the DTMF Collector media service information via the message media_get_server_r.

B3. The ESP Starter requests a new session with the DTMF Collector media service via the message: media_start_session_q.

B4. The DTMF Collector media service opens a new session, returns the channel it has reserved for the ESP Starter, and provides a UDP port via the message media_start_session_r.

B5. DTMF Collector media service informs the Media Manager of its status (e.g., number of busy channels) via the message media_status_m.

The IP packets flowing over the voice channel may contain voice or DTMF tones. As shown in step B6 of FIG. 4b, when the collector recognizes a DTMF tone in a packet, it converts the tone to its corresponding number or symbol and sends a message with this information to the ESP application that requested tone services. To achieve this, in step B6, the DTMF Collector reviews the packet headers to determine whether the packet is voice or DTMF. If it is DTMF, the DTMF Collector will interpret the tones and convert them to numbers or symbols via the message pc_button_m.

As shown in steps B7-B8 of FIG. 4c, when the ESP application no longer needs DTMF tone detection, a message is sent to the DTMF collector telling it to stop listening on the voice channel. The ESP application still has control of the call and may use other ESP services as needed. To achieve this, illustratively steps B7-B8 of the tone collecting method are performed as follows:

B7. When the channel and session is no longer required the ESP Starter notifies the DTMF Collector that they can be dropped via the message media_end_session_q.

B8. The DTMF Collector media service acknowledges the message and drops the channel and ends the session via the message media_end_session_r.

For ease of reference, FIG. 4d shows the entirety of the process of requesting, obtaining and releasing DTMF detection services using the ESP platform 260.

### EXAMPLE 3

### Playing Prompts and Text-to-speech

This example describes the message sequencing that takes place when an application wants to play prompts to a caller. Prompts are a common way to inform a caller of information the caller needs to input or to provide feedback to the caller as call processing progresses. The text-to-speech capability allows an application to specify a text string to be translated to voice and played to a caller as opposed to a pre-recorded voice prompt. (Alternatively, pre-recorded voice prompts can be loaded and played as well. In light of the centralized storage that is available to the servers running the media services, a single prompt may be played from different servers but only stored once within the network.)

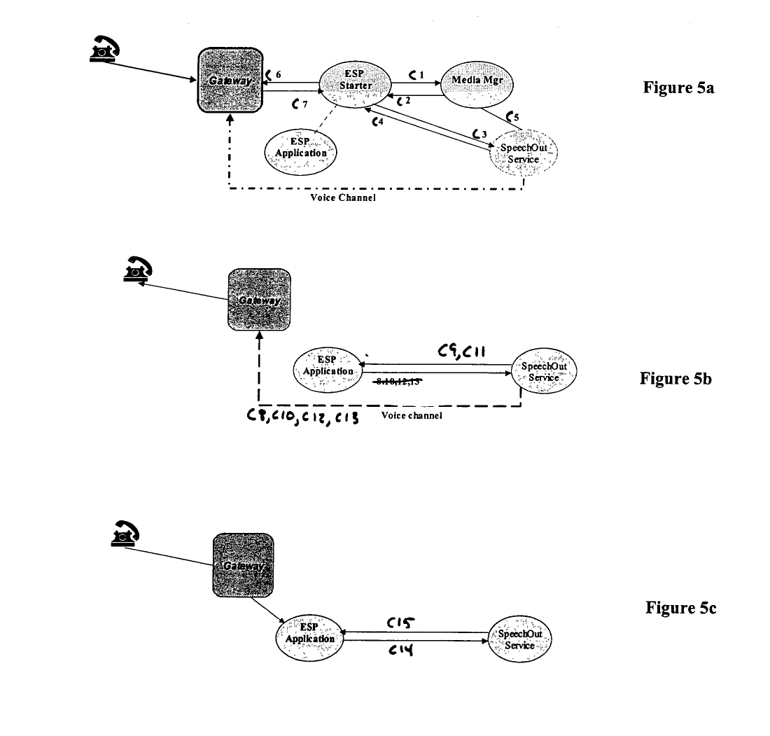

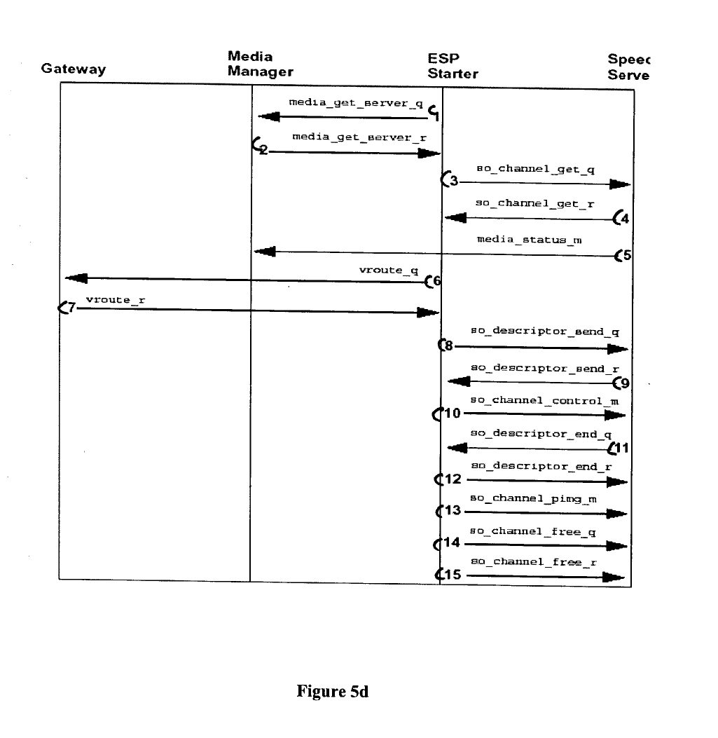

As shown in FIG. 5a, an ESP Starter sends a message to the Media Manager requesting access to a Speech Out Server on behalf of an ESP application that has requested this service. An application can request this service at startup or during the course of the application flow. The ESP Starter requests both a service and a voice channel from the media service and then informs the gateway. A voice channel is now established between the SpeechOut service and the Gateway. The application can request prompts be played, etc. to the caller. The Media Manager process keeps track of the status and availability of the SpeechOut service through status messages sent to it by the Speech Out Service (message C5). To achieve this, illustratively steps C1-C7 of a prompt playing method are performed as follows:

C1. The ESP Starter requests a SpeechOut media service from the Media Manager message: media_get_server_q.

C2. The Media Manager returns the Speech Out media service information via the message media_get_server_r.

C3. The ESP Starter requests a channel from the Speech Out media service via the message so_channel_get_q.

C4. The Speech Out media service returns the channel it has reserved for the ESP Starter via the message so_channel_get_r.

C5. Speech Out media service informs the Media Manager of its status (e.g., number of busy channels) via the message media_status_m.

C6. The ESP Starter notifies the Gateway via the Call Controller of the UDP port and Speech Out media service IP address via the message vroute_q. TheGateway will listen to all voice traffic from the SpeechOut media service.

C7. Gateway acknowledges the message from the application via the Call Controller via the message vroute_r.

With reference to FIG. 5b, a prompt (or other speech including speech converted from text) is played to a caller. An application sends messages to the SpeechOut Service informing it of an audio prompt or text file to be played on the voice channel. An application has several options that allow it to control the playing of a prompt or text to the caller. These options allow the application to pause, resume, rewind or barge into (suspend playing) a prompt. Used in conjunction with a DTMF collector, an application can use prompts to request the user to enter information and a DTMF collector to be informed of the digits a user has entered. To achieve this, illustratively steps C8-C13 of a prompt playing method are performed as follows:

C8. The ESP Starter tells the Speech Out media service which audio files to play and/or which text to convert to speech via the message so_descriptor_send_q.

C9. The Speech Out media service acknowledges the new task via the message so_descriptor_send_r.

C10. The ESP Starter may send this optional message to barge, pause, resume, rewind, or start the tasks listed in Step 8 via the message so_channel_control_m.

C11. The Speech Out media server notifies the ESP Starter when all tasks have been completed via the message so_descriptor_end_q.

(Only one message is sent regardless of the number of so_descriptor_send_q messages sent.)

C12. The ESP Starter acknowledges the message indicating that the tasks are completed via the message so_descriptor_end_r.

C13. The ESP Starter may send this optional message to prevent the SpeechOut media service from dropping its channel after a period of disuse via the message so_channel_ping_m.

When the ESP application no longer needs to play prompts or text, it sends a message to the Speech Out Service telling it to drop the voice channel. The ESP application still has control of the call and may use other ESP services as needed. To achieve this, illustratively steps C14-C15 of a prompt playing method are performed as follows:

C14. The ESP Starter instructs the Speech Out media server that it no longer requires the channel and that it can be dropped via the message so_channel_free_q.

C15. The Speech Out media service acknowledges the message and drops the channel via the message so_channel_free_r.

For ease of reference, FIG. 5d shows the entirety of the process of requesting, obtaining and releasing prompt and/or text-to-speech services using the ESP platform 260.

### EXAMPLE 4

### Automatic Speech Recognition (ASR)

This example describes the message sequencing that takes place when an application wants to recognize words and phrases spoken by a caller. Automatic speech recognition is another way in which an application can obtain information from a caller.

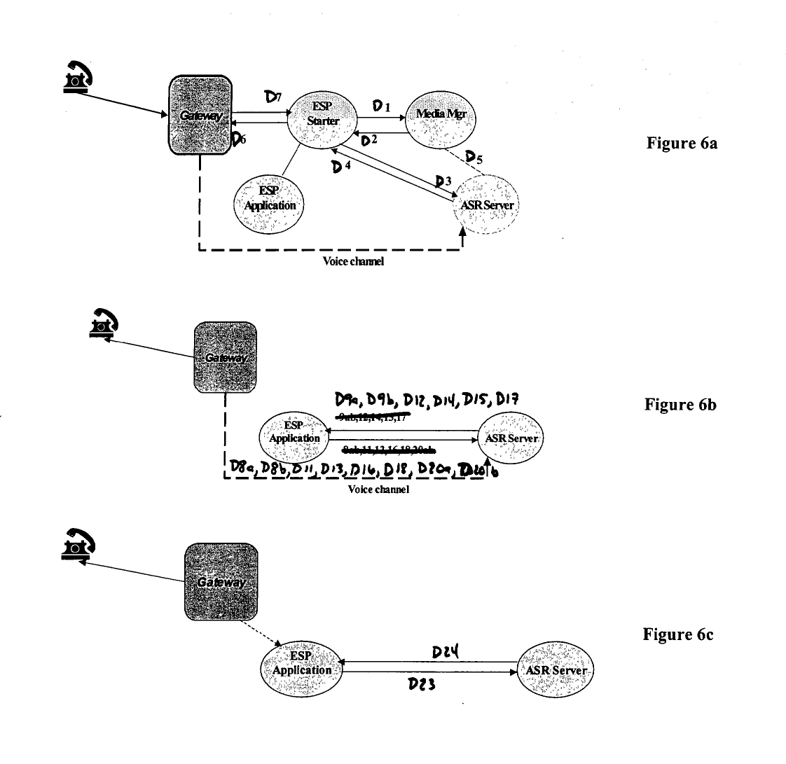

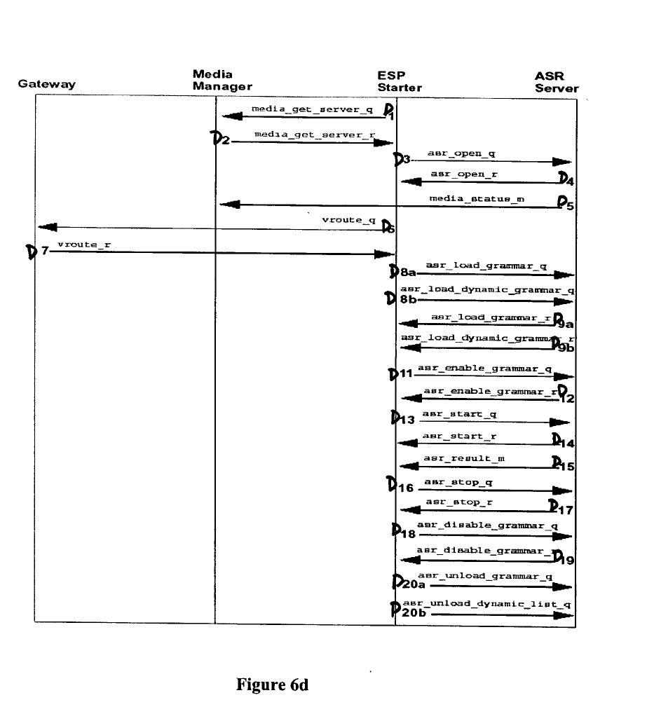

As shown in FIG. 6a, an ESP Starter sends a message to the Media Manager 280 requesting access to an ASR Server on behalf of an ESP application that has requested this service. An application can request this service at startup or during the course of the application flow. The ESP Starter requests service and a voice channel from the ASR Service and then informs the gateway. The ASR Server is now listening on the voice channel. The Media Manager process keeps track of the status and availability of the ASR Service through status messages sent to it by the ASR server (message D5). To achieve this, illustratively steps D1-D7 of a speech recognition method are performed as follows:

D1. The ESP Starter requests an Automatic Speech Recognition media service from the Media Manager via the message media_get_server_q.

D2. The Media Manager returns the Automatic Speech Recognition media service information via the message media_get_server_r.

D3. The ESP Starter requests a session channel with the Automatic Speech Recognition media service via the message asr_open_q.

D4. The Automatic Speech Recognition media service opens a session and returns the channel it has reserved for the ESPStarter via the message asr_open_r.

D5. Automatic Speech Recognition media service informs the Media Manager of its status (e.g., number of busy channels) via the message media_status_m.

D6. The ESP Starter notifies the Gateway via the Call Controller of the UDP port and Automatic Speech Recognition service IP address.message: vroute_q The Gateway will send all voice traffic to the Automatic Speech Recognition Server.

D7. Gateway acknowledges the message from the ESP Starter via the Call Controller via the message vroute_r.

The ESP application has control over which grammars (set of words and phrases) will be used by the voice recognition engine. As shown in FIG. 6b, an application may request static or dynamic grammars be loaded and may enable or disable individual grammars by sending the appropriate message to the ASR server. The application also has control over when speech recognition begins and ends. When an application tells the ASR server to start voice recognition, the server listens to the voice channel and reports grammar matches back to the application. To achieve this, illustratively steps D8-D20bof a speech recognition method are performed as follows:

D8. The ESP Starter does one of the following:

a. Informs the Automatic Speech Recognition media service which static voice grammar to load via the message asr_load_grammar_q.

b. Informs the Automatic Speech Recognition media service which dynamic voice grammar to load via the message asr_load dynamic_grammar_q.

D9. The Automatic Speech Recognition media service does one of the following:

a. Acknowledges the new static voice task via the message asr_load_grammar_r.

b. Acknowledges the new dynamic voice grammar task via the message asr_load_dynamic_grammar_r.

D10. The ESP Starter may repeat Step D8 for each static or dynamic grammar required by the current ESP application.

D11. The ESP Starter informs the Automatic Speech Recognition media service which static and/or dynamic voice grammar to enable via the message asr_enable_grammar_q.

D12. The Automatic Speech Recognition media service acknowledges the new task via the message asr_enable_grammar_r message. The ESP Starter may repeat Step D11 for each static or dynamic grammar required by the current ESP application.

D13. The ESP Starter directs the Automatic Speech Recognition media server to begin recognition on the inbound voice stream via the message asr_start_q.

D14. The Automatic Speech Recognition media service acknowledges the message and starts voice recognition on the channel via the message asr_start_r.

D15. The Automatic Speech Recognition media service reports a match on an enabled grammar via the message asr_result_m.

D16. The ESP Starter directs the Automatic Speech Recognition media server to stop recognition on the inbound voice stream via the message asr_stop_q.

D17. The Automatic Speech Recognition media service acknowledges the message and stops voice recognition via the message asr_stop_r.

D18. The ESP Starter informs the Automatic speech Recognition media service which static and/or dynamic voice to disable via the message asr_disable_grammar_q.

D19. The Automatic Speech Recognition media service acknowledges the new task via the message asr_disable_grammar_r.

D20. The ESP Starter does one of the following:

a. Informs the Automatic speech Recognition media service which static grammar to unload via the message asr_unload_grammar_q.

b. Informs the Automatic speech Recognition media service which dynamic grammar to unload via the message asr_unload dynamic_list_q.

When the ESP application no longer needs speech recognition services, a message is sent to the ASR Server telling it to stop listening on the voice channel. The ESP application still has control of the call and may use other ESP services as needed. To achieve this, illustratively steps D23-D24 of a speech recognition method are performed as follows:

D23. After receiving a asr stop r message, the ESP Starter does one of the following:

a. Informs the Automatic Speech Recognition media service which grammar to load. Go to Step D8 via the message asr_load_grammar_q or asr_load_dynamic_grammar_q.

b. Instructs the Automatic Speech Recognition media server that it no longer requires the channel and session and that they can be dropped via the message asr_close_q.

D24. The Automatic Speech Recognition media service acknowledges the message and drops the channel via the message asr_close_r.

For ease of reference, FIG. 6d shows the entirety of the process of requesting, obtaining and releasing speech recognition services using the ESP platform 260.

### EXAMPLE 5

### Recording Voice

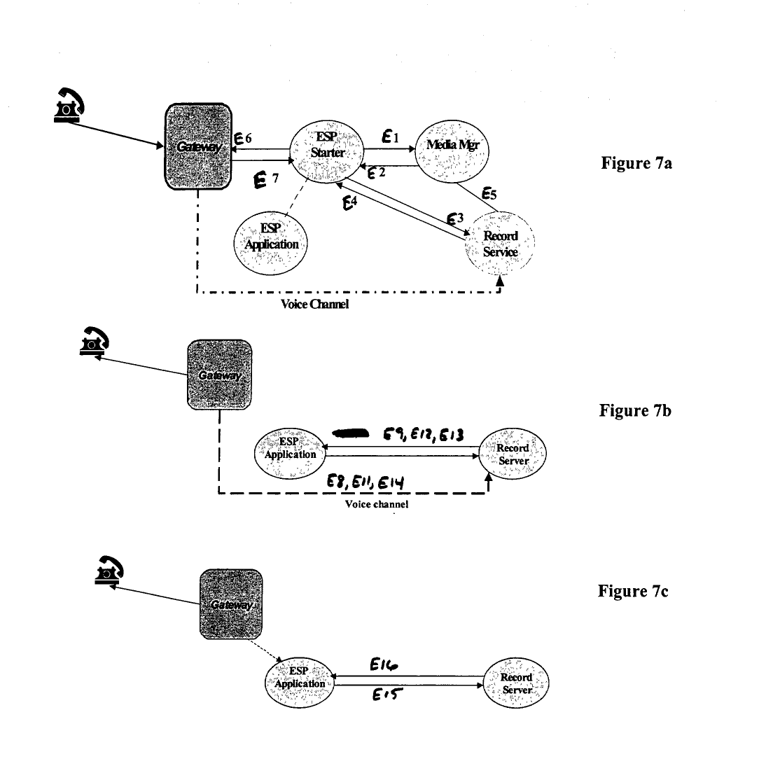

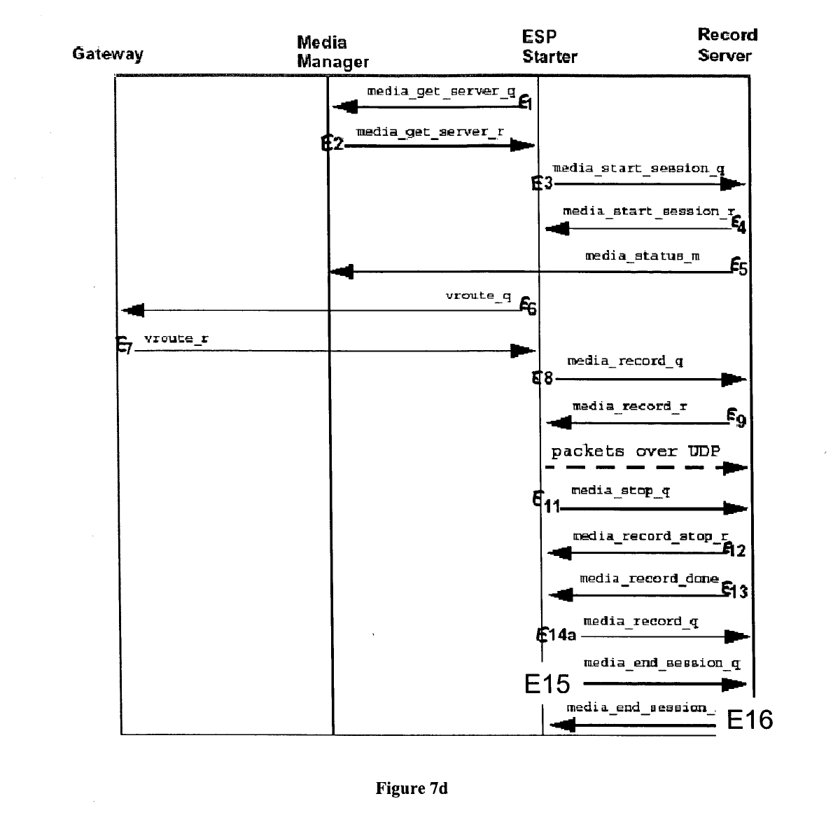

ESP applications have the ability to make and store recordings of a caller's voice. As shown in FIG. 7a, an ESP Starter sends a message to the Media Manager requesting access to a Record Server on behalf of an ESP application that has requested this service. An application can request this service at startup or during the course of the application flow. The ESP Starter requests service and a voice channel from the Record Server and then informs the gateway. The Record Server is now listening on the voice channel. The Media Manager process keeps track of the status and availability of the Record Service through status messages sent to it by the record service (message E5). To achieve this, illustratively steps E1-E7 of a speech recording method are performed as follows:

E1. The ESP Starter requests a Record media service from the Media Manager via the message media_get_server_q.

E2. The Media Manager returns the Record media service information via the message media_get_server_r.

E3. The ESP Starter requests a new session with the Record media service via the message media_start_session_q.

E4. The Record media service opens a new session, returns the channel it has reserved for the ESP Starter, and provides a UDP port via the message media_start_session_r.

E5. Record media service informs the Media Manager of its status (e.g., number of busy channels) via the message media_status_m.

E6. The ESP Starter notifies the Gateway via the Call Controller of the UDP port and Record media service IP address via the message vroute_q The Gateway will send all voice traffic to the Record media service to be recorded.

E7. Gateway acknowledges the message from the ESP Starter via the Call Controller via the message vroute_r.

As shown in FIG. 7b, the ESP application can now request a file where the voice recording will be stored and can request the server begin recording from the voice channel. To achieve this, illustratively steps E8-E14a of a speech recording method are performed as follows:

E8. The ESP Starter requests a new record file via the message media_record_q.

E9. The Record media service acknowledges the request and provides a record file name via the message media_record_r.

E10. The ESP Starter sends the voice packets via the UDP port.

E11. When the recording is complete, the ESP Starter informs the Record media service it can stop recording via the message media_stop_q.

E12. The Record media service acknowledges the message, stops recording, and provides information about the record file via the message media_record_stop_r.

E13. The Record media service may stop the recording based on the parameters sent in the media_record_q message via the message media_record_done. This message is sent prior to and in place of the media stop_q and media_record_stop_r messages.

E14. After receiving a media_record_done or a media_record_stop_r message the ESP Starter does one of the following:

a. Requests a new record file. Go to Step E9 via the message media_record_q.

b. Goes to step E15 to release the recording resources.

With reference to FIG. 7c, when the ESP application is done recording, a message is sent to the Record Server telling it to stop listening on the voice channel. The ESP application still has control of the call and may use other ESP services as needed. To achieve this, illustratively steps E15-E16 of a speech recording method are performed as follows:

E15. The ESP Starter instructs the Record media service that it no longer requires the channel and session and that they can be dropped. Go to Step E16 via the message media_end_session_q.

E16. The Record media service acknowledges the message and drops the channel and ends the session via the message media_end_session_r.

For ease of reference, FIG. 7d shows the entirety of the process of requesting, obtaining and releasing voice recording services using the ESP platform 260.

### EXAMPLE 6

### Disposition Services

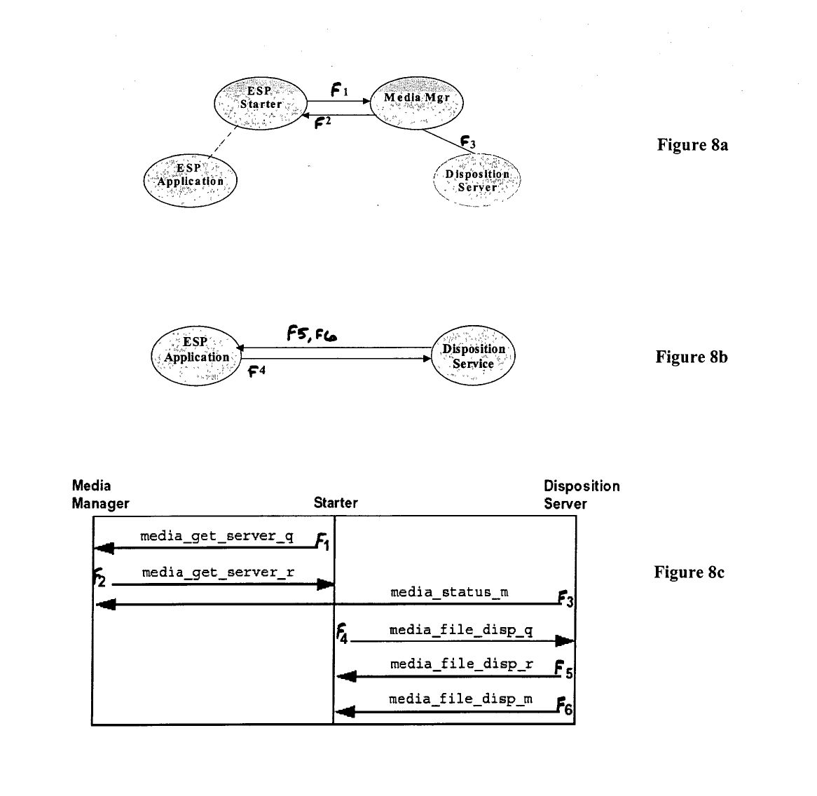

ESP applications have the ability to request that recorded voice files be disposed of. An application can request that a file be deleted, transferred, emailed or transcoded into other codec formats different from the original recording. For example, if a voicemail is recorded but is unsatisfactory, a user may select to delete the voicemail by providing an appropriate response to the DTMF detection or voice recognition servers. As shown in FIG. 8a, an ESP Starter sends a message to the Media Manager requesting access to a Disposition Server on behalf of an ESP application that has requested this service. An application can request this service at startup or during the course of the application flow. The Media Manager process keeps track of the status and availability of the Disposition Service through status messages sent to it by the server (message F3). To achieve this, illustratively steps F1-F3 of a file disposition method are performed as follows:

F1. The ESP Starter requests a Voice Disposition media service from the Media Manager via the message media get_server_q.

F2. The Media Manager returns the Voice Disposition media service information via the message media_get_server_r.

F3. Voice Disposition media service informs the MediaManager of its status (e.g., number of busy channels) via the message media_status_m.

An ESP application can now send messages to the Disposition Service requesting the server to dispose of referenced files. To achieve this, illustratively steps F4-F5 of a file disposition method are performed as follows:

F4. The ESP Starter instructs the Voice Disposition media service what to do with the referenced file (transfer, e-mail, delete, etc) via the message media_file disp_q.

F5. The Voice Disposition media service acknowledges the task via the message media_file_disp_r.

F6. The Voice Disposition media service informs the ESP Starter when the task is completed if the task was assigned a high priority in media_file_disp_q.

For ease of reference, FIG. 8c shows the entirety of the process of requesting and obtaining file disposition services using the ESP platform 260.

### EXAMPLE 7

### Outbound Call Setup

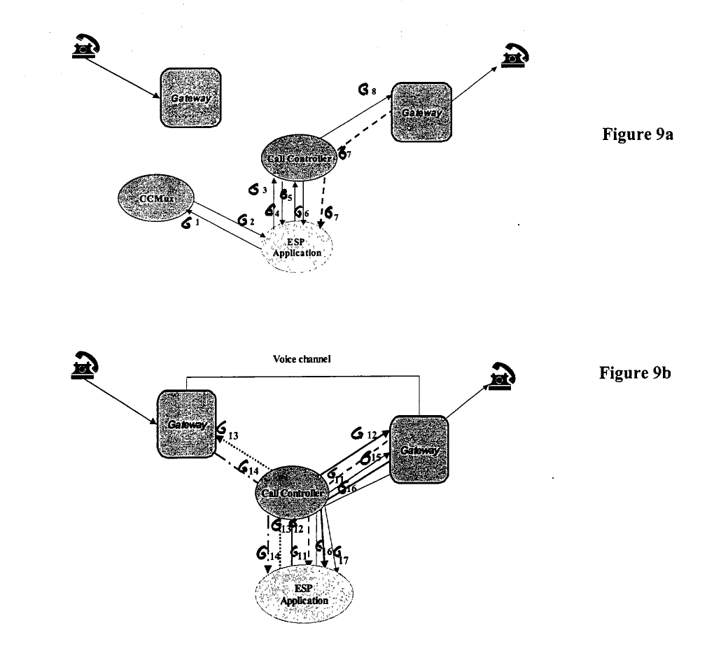

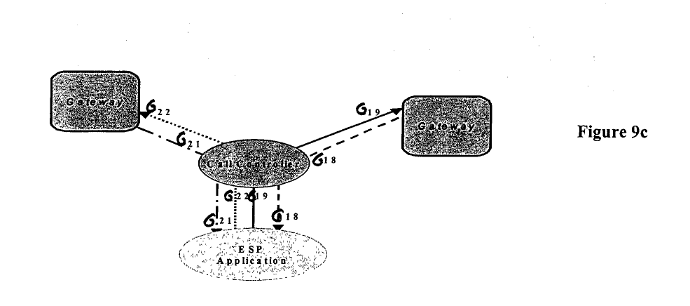

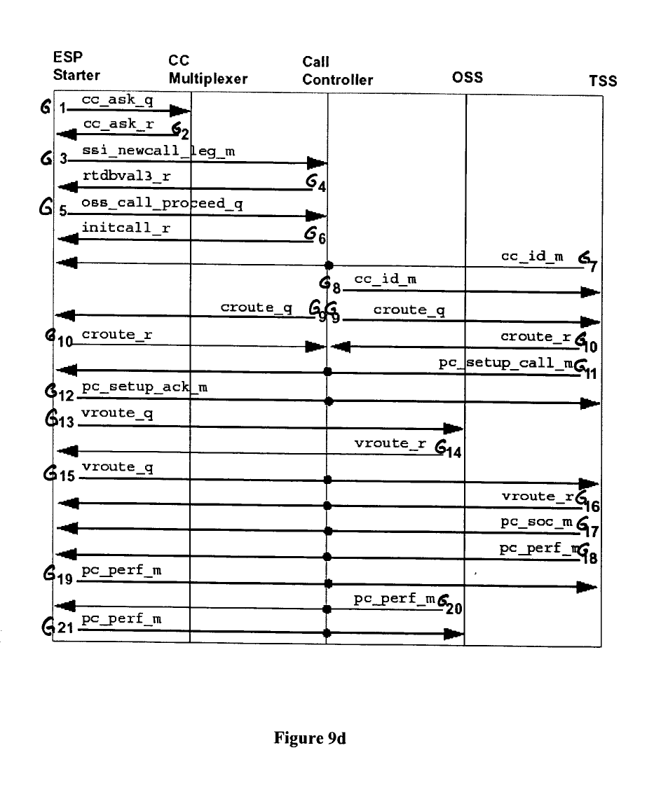

This example describes the message sequencing that takes place when an ESP application wants to dial an outbound call. At the end of this message sequence an outbound call has been dialed by a gateway and a voice channel has been established between the two gateways. As shown in FIG. 9a, an ESP application requests a call controller from the platform CCMux process. The call controller is responsible for forwarding all call control requests made by an ESP application to the inbound and/or outbound gateways. The ESP application asks the call controller to validate that a call can be made (e.g., dialed number, account information, etc. is valid). If the call request is valid, the application requests the call controller to setup the outbound call. The call controller asks the N2P platform to select an outbound gateway. The outbound gateway acknowledges its selection to the call controller and the ESP application. An outbound call can now be made by the ESP application. To achieve this, illustratively steps G1-G8 of an outbound call setup method are performed as follows:

G1. The ESP Starter requests a Call Controller from the Call Controller Multiplexer via the message cc_ask_r.

G2. The Call ControllerMultiplexer provides a Call Controller to the ESP Starter via the message cc_ask_r.

G3. The ESP Starter provides the Call Controller with the account and dialed number information and asks it to determine whether an outbound call can be made via the message ssi_newcall_leg_m.

G4. The Call Controller validates the account and dialed number information in the platform database and informs the ESP Starter an outbound call is permitted via the message rtdbval3_r.

G5. The ESP Starter asks the Call Controller to make the call via the message oss_call_proceed_q.

G6. The Call Controller asks the Routing Manager to route the call. The Routing Manager routes the call via the message initcall_r.

G7. The Gateway 230b acknowledges the call to the ESP Starter via the Call Controller via the message cc_id_m.

G8. The Call Controller acknowledges the message from the Gateway 230b at the same time it routes the cc_id_m message to the ESP Starter via the message cc_id_m.

As shown in FIG. 9b, the outbound Gateway 230b informs the ESP call control of its call capabilities and ESP responds back to the gateway telling it what parameters to use for the call. ESP call control then notifies both gateways (inbound) 230a and (outbound) 230b of the routing information and call parameters to use on the call. The outbound gateway dials the outbound call and notifies ESP that the call is setup and active. At this point the caller is connected to the called party. To achieve this, illustratively steps G11-G17 of an outbound call setup method are performed as follows:

G9. The Call Controller forwards the alternate Call Controller information to the Gateway 230b and the ESP Starter via the message croute_q.

G10. The Gateway 230b and the ESP Starter acknowledge receipt of the alternate Call Controller information via the message croute_r.

G11. The Gateway 230b sends call information as well as broadcasts what available call flags are available via the message pc_setup_call_m.

G12. The ESP Starter acknowledges the call information and informs the Gateway 230b which CODECs and call flags to use via the message pc_setup_ack_m.

G13. The ESP Starter tells the Gateway 230a where to talk and listen via the message vroute_q.

G14. The Gateway 230a acknowledges the ESP Starter instructions via the message vroute_r.

G15. The ESP Starter tells the Gateway 230b where to talk and listen via the message vroute_q.

G16. The Gateway 230b acknowledges the ESP Starter instructions via the message vroute_r.

G17. The Gateway 230b informs the ESP Starter via the Call Controller that the call is active via the message pc_soc_m.

As shown in FIG. 9c, while the call is connected, the gateways and ESP notify each other of their status by sending ‘keep alive’ messages back and forth. To achieve this, illustratively steps G18-G22 of an outbound call setup method are performed as follows:

G18. The Gateway 230b broadcasts a “keep alive” message to the ESP Starter via the message pc_perf_m.

G19. The ESP Starter acknowledges the keep alive message via the message pc_perf_m.

G21. The Gateway 230a broadcasts a keep alive message to the ESP Starter via the message pc_perf_m.

G22. The ESP Starter acknowledges the keep alive message via the message pc_perf_m.

For ease of reference, FIG. 9d shows the entirety of the process of requesting and obtaining outbound call setup services using the ESP platform 260.

### EXAMPLE 8

### Call Termination

A call can be terminated in one of three ways—the caller hangs up, the called party hangs up or the ESP application ends the call. This section explains what happens in each of these cases.

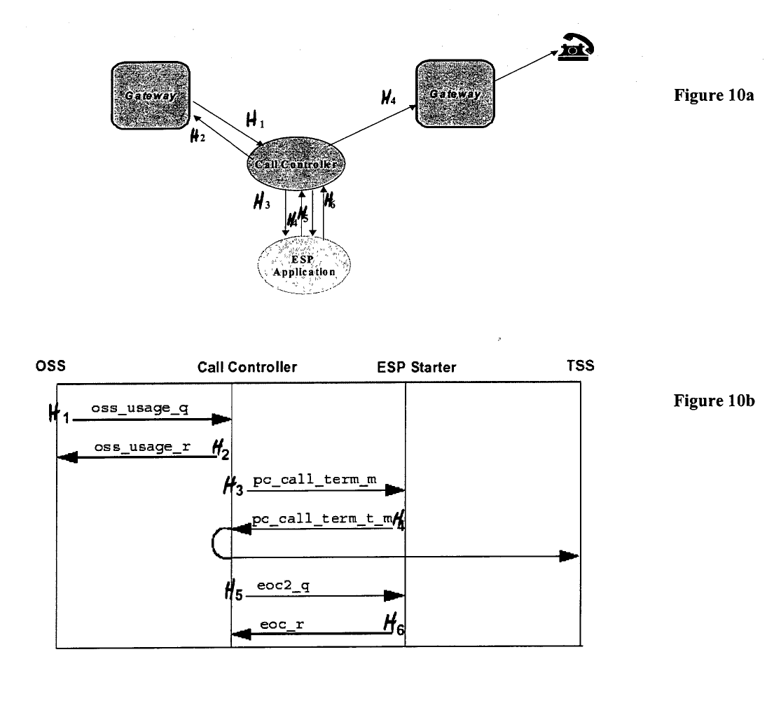

As shown in FIG. 10a, when the caller hangs up (inbound call leg termination), the inbound gateway notifies the call controller. The call controller notifies ESP that the call has been terminated and ESP notifies the outbound gateway of the call termination. The ESP application notifies the call controller that the call has ended and the billing record for the call is updated. To achieve this, illustratively steps H1-H6 of an inbound call termination method are performed as follows:

H1. The person who made the call hangs up via the message oss_usage_q.

H2. The Call Controller acknowledges that the call has been terminated via the message oss_usage_r.

H3. The Call Controller informs the ESP Starter that the call has been terminated via the message pc_call_term_m.

H4. If there is a Gateway 230b, the ESP Starter will hang up the connection t o the Gateway 230b via the Call Controller via the message pc_call_term_t_m.

H5. Starter notifies the Call Controller to update the Call Detail Record with the correct end of call time and reason via the message eoc2_q.

H6. The Call Controller acknowledges the new task via the message eoc_r.

For ease of reference, FIG. 10b shows the entirety of the process of an inbound call termination using the ESP platform 260.

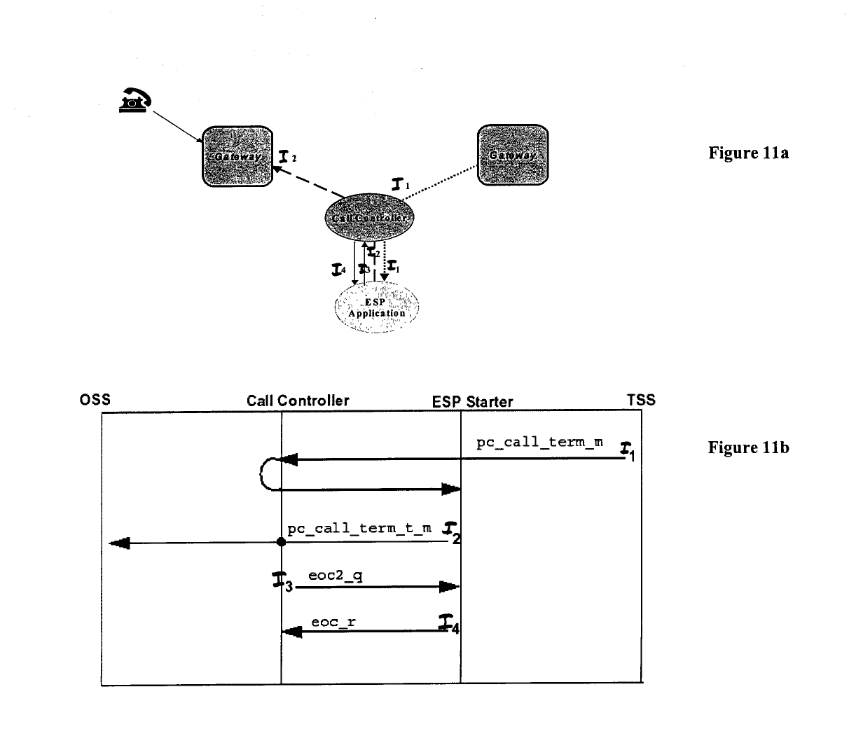

As shown in FIG. 11a, when the called party hangs up (outbound call termination), the outbound gateway notifies the ESP application and the ESP application notifies the inbound gateway that the call has terminated.(An ESP application may decide not to drop the inbound call when the outbound call hangs up, but, for example, instead put a prompt server and DTMF collector back on the call and direct the inbound call to the prompt server, and ask the inbound caller to enter another number they would like to call) ESP sends notification to the call controller that the call has ended and the billing record for the call is updated. To achieve this, illustratively steps I1-I4 of an outbound call termination method are performed as follows:

I1. The person who received the call hangs up. The ESP Starter is notified via the Call Controller via the message pc_call_term_m.

I2. If necessary, the ESP Starter will hang up the connection to the OSS via the Call Controller via the message pc_call_term_t_m.

I3. Starter notifies the Call Controller to update the Call Detail Record with the correct end of call time and reason via the message eoc2_q.

I4. The Call Controller acknowledges the new task via the message eoc_r.

For ease of reference, FIG. 11b shows the entirety of the process of an outbound call termination using the ESP platform 260.

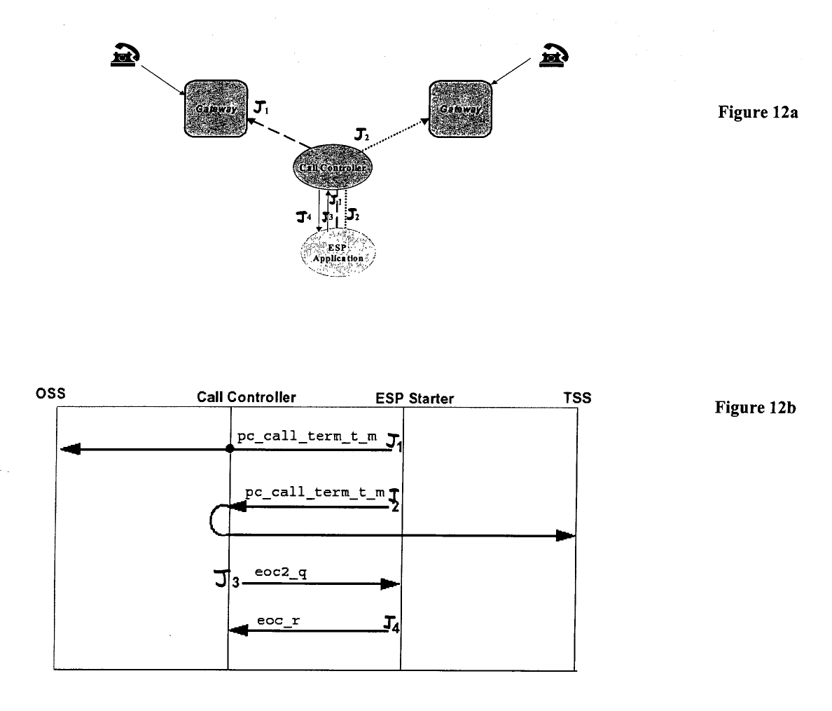

As shown in FIG. 12a, if the ESP application decides to terminate the call, it sends a termination message to both the inbound and outbound gateways. It then notifies the call controller that the call has ended so the billing record can be updated. To achieve this, illustratively steps J1-J4 of an application termination method are performed as follows:

J1. ESP Starter hangs up the connection to the OSS via the Call Controller via the message pc_call_term_t_m.

J2. If there is a TSS on the call, the ESP Starter hangs up the connection to the TSS via the Call Controller via the message pc_call_term_t_m.

J3. Starter notifies the Call Controller to update the Call Detail Record with the correct end of call time and reason via the message eoc2_q.

J4. The Call Controller acknowledges the new task via the message eoc_r.

For ease of reference, FIG. 12b shows the entirety of the process of an application call termination using the ESP platform 260.

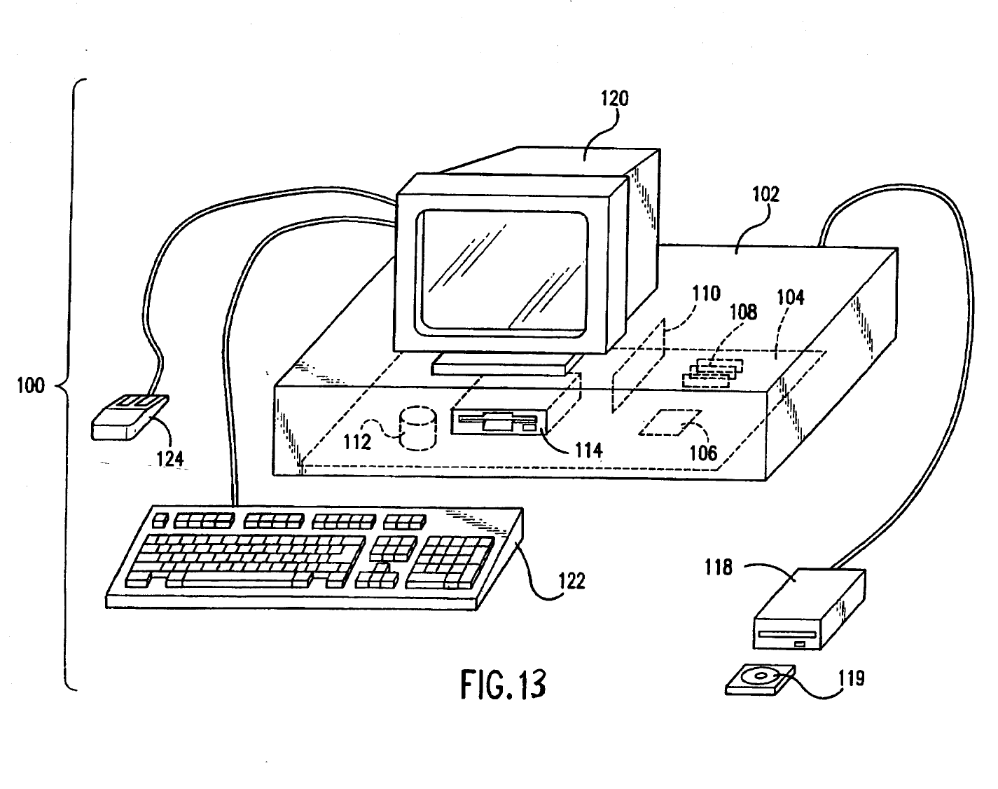

As described herein, the components of the platform 260 can be implemented on one or more computers capable of receiving and/or transmitting voice and data packets. An exemplary computer for implementing at least a portion of the platform 260 is illustrated in FIG. 13. A computer 100 implements the method of the present invention, wherein the computer housing 102 houses a motherboard 104 which contains a CPU 106, memory 108 (e.g., DRAM, ROM, EPROM, EEPROM, SRAM, SDRAM, and Flash RAM), and other optional special purpose logic devices (e.g., ASICs) or configurable logic devices (e.g., GAL and reprogrammable FPGA). The computer 100 also includes plural input devices, (e.g., a keyboard 122 and mouse 124), and a display card 110 for controlling monitor 120. In addition, the computer system 100 further includes a floppy disk drive 114; other removable media devices (e.g., compact disc 119, tape, and removable magneto-optical media (not shown)); and a hard disk 112, or other fixed, high density media drives, connected using an appropriate device bus (e.g., a SCSI bus, an Enhanced IDE bus, or a Ultra DMA bus). Also connected to the same device bus or another device bus, the computer 100 may additionally include a compact disc reader 118, a compact disc reader/writer unit (not shown) or a compact disc jukebox (not shown). Although compact disc 119 is shown in a CD caddy, the compact disc 119 can be inserted directly into CD-ROM drives which do not require caddies. In addition, a printer (not shown) also provides printed listings of the history of voice services provided by the platform 260 and/or the current utilization of those services.

As stated above, the system includes at least one computer readable medium. Examples of computer readable media are compact discs 119, hard disks 112, floppy disks, tape, magneto-optical disks, PROMs (EPROM, EEPROM, Flash EPROM), DRAM, SRAM, SDRAM, etc. Stored on any one or on a combination of computer readable media, the present invention includes software for controlling both the hardware of the computer 100 and for enabling the computer 100 to interact with a human user. Such software may include, but is not limited to, device drivers, operating systems and user applications, such as development tools. Such computer readable media further includes the computer program product of the present invention for providing at least one of the services of platform 260. The computer code devices of the present invention can be any interpreted or executable code mechanism, including but not limited to scripts, interpreters, dynamic link libraries, Java classes, and complete executable programs. Computer code devices as used herein can also be a combination of general or special purpose hardware programmed to perform the switching services of the present invention. Computer code devices may additionally be dynamically updated or loaded by being received over a network (either wired or wireless).

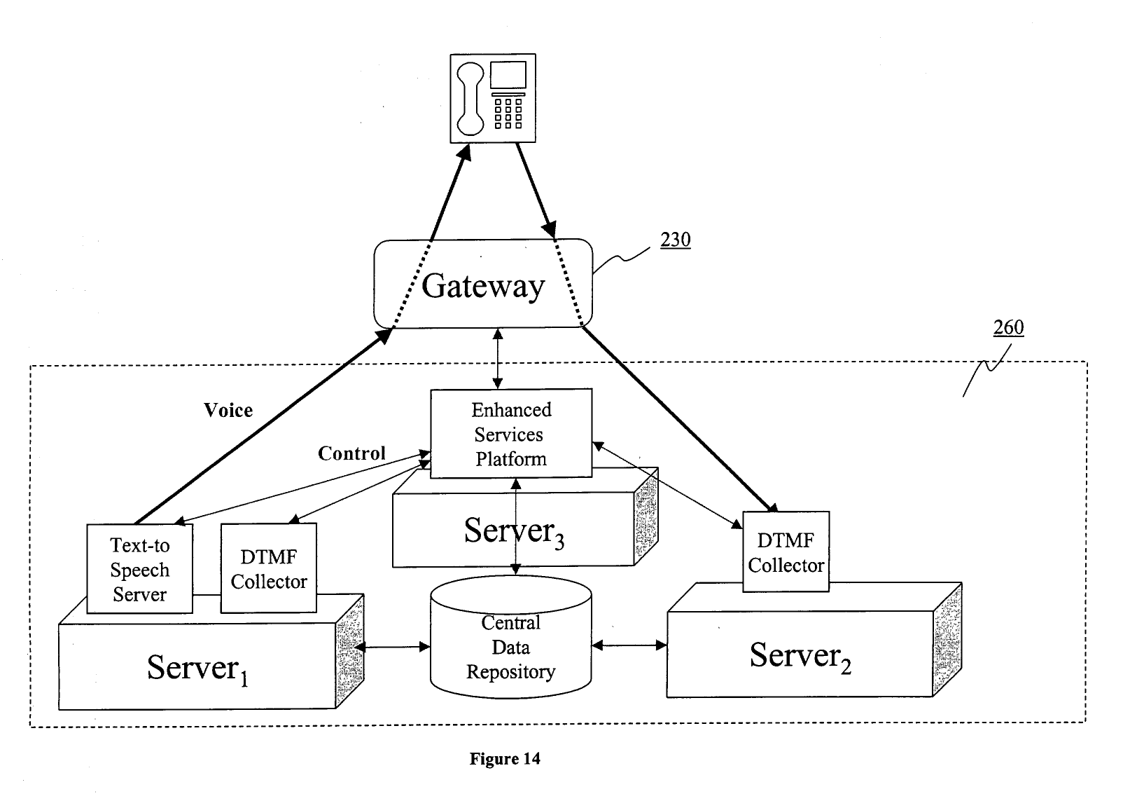

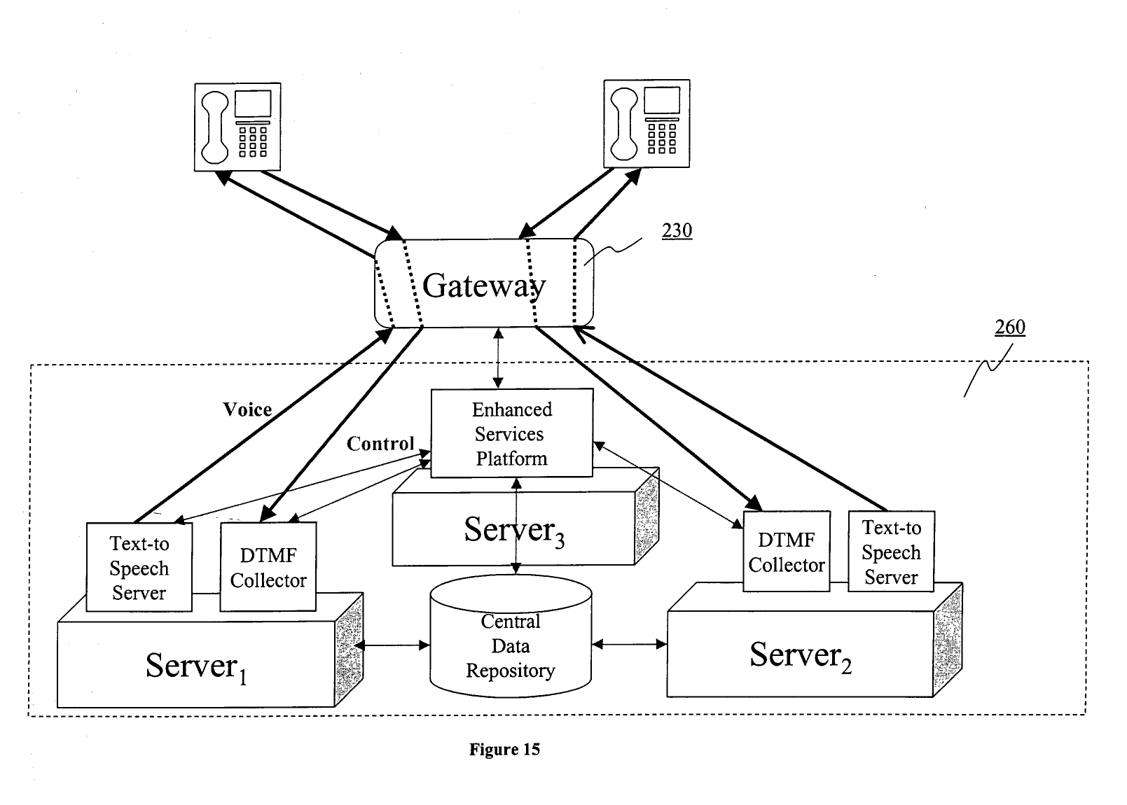

FIG. 14 is a block diagram of a single telephone utilizing the services of two media servers simultaneously. In the illustrated embodiment, the telephone is receiving voice signals (transmitted to the gateway 230 as voice packets) from the text-to-speech server running on server1 while sending voice and DTMF signals to the DTMF collector running on server2. While server1 has (in the illustrated embodiment) the capability to provide the same DTMF services as provided by server2, for load balancing reasons (or other reasons), the enhanced services platform uses the DTMF collector services on server2. By contrast, FIG. 15 illustrates the co-location of services on the same server as used in a single call. In FIG. 15, however, the enhanced services platform is utilizing the same types of services located on two different servers.

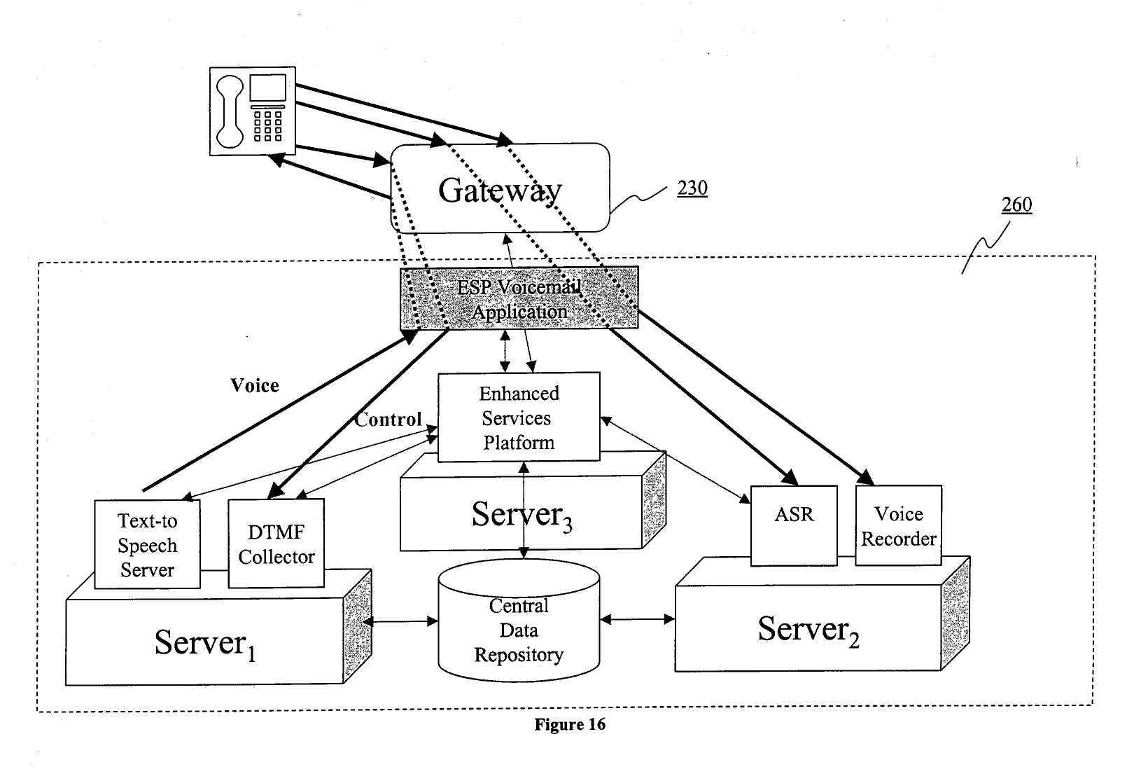

As shown in FIG. 16, it is also possible to build new ESP applications using existing media services. The voicemail service as illustrated in FIG. 16 is capable of (1) playing prompts to a user (e.g., “To leave a message, please press or say ‘One’”), (2) listening for a response from a user using either DTMF detection or voice recognition and (3) recording the message when the DTMF detection or voice recognition services indicate that the user has provided the proper response. In light of the packet nature of the services, the enhanced services platform allows both the DTMF detection and voice recognition services to operate in parallel but on different machines by being (quasi-simultaneously) each provided with a copy of any packets received from the user. Such a capability is provided by either a separate “voice splitter” service or via providing voice splitting services within the other components of the system that perform additional functions.

Moreover, the voicemail service of FIG. 16 can be further enhanced with other services as well. For example, a user can (1) delete and re-record messages (using the disposition services) or (2) have the message delivered as urgent to a user's email inbox (using the disposition services) or to their mobile phone (using outbound call setup services). Similarly, a user can leave a voicemail which is to be transcribed by the voice recognition service and returned to the user via email.

The services can also be enhanced using a variety of call information. Examples of such call information are ANI, ANI2, and DNIS information for PSTN calls. Similar information in the form of unique identifiers built into Internet devices or software can likewise be used. Such information can be used to define various services (e.g., prompts that are heard by a user, quality of service of a prompt and/or a connection to a callee, time restrictions on use, and call failure information routing). For example, all calls directed to an ESP application that are for a first phone number may have prompts played in one language while calls to another number have prompts played in a second language.

When an ESP application needs static or dynamic (e.g., time of day or length of call) information, that ESP application makes a query of either the central repository or a data services application that ultimately provides the data. Such services can be useful in providing time-of-day related services. One such service plays one set of prompts during normal business hours and another set of prompts during non-business hours. Also, the time can be queried to provide a service which confirms with a user that he wishes to call a number at a strange hour local time. By looking up the area code (or country code) of the destination and determining a time there, the ESP application can play a time-based prompt before completing a call. For example, if the destination country code is 33, the ESP application might request that the prompt server play the prompt “It is 2 AM local time in France, please press ‘one’ to complete the call, otherwise, please press ‘two’ to place a different call.” The call would then be routed to the DTMF service, as described above, to listen for the user's choice.

Based on the division of the call into separate inbound and outbound channels, other additional services can also be added. For example, by splitting the incoming stream into two parts (e.g., using a voice splitter service described above), a background monitor can “listen in” to a conversation that is additionally being routed to another service (e.g.,. voice recorder) or party. Thus, when participating in a call via the network, the gateway can listen in for call termination requests (e.g., hitting pound three times in a row or saying “terminate call”).

The same voice splitting service can be used to dynamically create conference calls between multiple parties. By hitting a predefined DTMF sequence (or by saying “Add conference participant”), the controlling ESP application can play prompts and listen for commands to complete another outbound call, thereby creating a multi-party call. Conferees can be added (or deleted) using this process without ever having a user “flash hook” her telephone apparatus. In this example, a call bridging service would be dynamically used and released as needed to have each party hear every other party.

Voice splitting also enables both sides of a call to be recorded separately. A conversation recorder can split the caller and callee sides of the calls into separate clients of the voice recorder such that their respective sides are recorded separately. The call could then be played back in its entirety by combining the two sides at playback time. Such recordings can be in any number of formats, such as MP3 or other compressed or non-compressed formats.formats.

Just as the ESP platform can perform outbound dialing in the case of a conference call, so can it perform outbound dialing from other applications (e.g., from the voicemail system described above). This enables users to not only hear the messages left by people but also return their calls. In a voicemail enviromnent that captures ANI or ANI2 information, a call may even be automatically dialed back to the party leaving the message by using the captured ANI or ANI2 information.

Moreover, just as an enhanced service can be implemented using plural basic services describe above (e.g., using speech prompts and DTMF detection), so too can more advanced services be provided by combining an enhanced service (e.g., basic voicemail) with other basic or enhanced services to quickly build the advanced services.

Yet another service that can be performed according to the present invention is the playing of pseudo-dynamically generated voice prompts. For example, stock market data changes dynamically during the trading day. Rather than actually playing a series of clips such as “Net2Phone” “is” “at” “5”, where each word is separately pulled from a database of words, it is possible to generate a new prompt “Net2Phone is at 5” once, and pull the whole phrase back as a clip dynamically. That would reduce the number of word requests made by the ESP application to the central repository. It would also reduce the number of times that the price value would have to be dynamically generated from the live stock market data using text-to-speech conversion. Reductions in text-to-speech conversion may result in lowering the processing load on the server. The frequency of the updating of the quote would likely be set by the ESP application and could change at a different rate than the underlying data. For example, stock market data might only be updated every few minutes rather than after every trade. In such cases, the prompt may even be recorded as a single phrase that says “At noon, Net2Phone was at 5”.

981 Another service that is possible is the ability to switch from voice to fax services dynamically, simply by controlling what end point sends or receives the data. For example, once a user is connected to a fax service, a user may enter a series of telephone numbers, each separated by a special key (e.g., ‘#’ or ‘*’) and then hit a predetermined sequence (e.g., ‘#*#’) which redirects the rest of the voice to a fax application that receives a fax from the user and then retransmits that fax to the numbers on the list. Separately, a user may log onto a fax box and request that pending faxes be sent to it after a pressing a series of keys.

Many of the applications described above may be customized using a series of scripts or menus. Such scripts and menus may be modified using a web interface or other interactive protocol. They may also be “uploaded” using various file transfer utilities (e.g., file transfer protocol (FTP)). Such scripts can be written in any number of languages (e.g., JTAPI or VXML). New voice prompts can similarly be uploaded to the server.

Obviously, numerous modifications and variations of the present invention are possible in light of the above teachings. It is therefore to be understood that, within the scope of the appended claims, the present invention may be practiced otherwise than as specifically described herein.

1. A computer-implemented method for controlling a packet-switched network to provide independent, enhanced telephone services, the method comprising:
determining a service type for an incoming connection request;
directing the incoming connection request to a first service of plural services provided by a packet network voice platform;
directing voice packets to the first service provided by a packet network voice platform; and
directing voice packets from a second service of the plural services provided by a packet network voice platform independent of receiving packets for the first service.

2. The method as claimed in claim 1, wherein the first service comprises a speech recognition service.

3. The method as claimed in claim 1, wherein the first service comprises a record server.

4. The method as claimed in claim 1, wherein the first service comprises a DTMF Collector.

5. The method as claimed in claim 1, wherein the second service comprises a Text-to-Speech Server.

6. The method as claimed in claim 1, wherein the second service comprises a Prompt Server.

7. The method as claimed in claim 1, wherein the first and second services are implemented on a single machine.

8. The method as claimed in claim 1, wherein the first service is implemented on a first machine and the second service is implemented on a second machine.

9. The method as claimed in claim 8, further comprising the step of load balancing the first and second services between the first and second machines.

10. The method as claimed in claim 1, wherein the first and second services are implemented on a single machine.

11. A computer program product, comprising a computer storage medium and code embedded in the computer storage medium for controlling a CPU to perform the steps of:
determining a service type for an incoming connection request;
directing the incoming connection request to a first service of plural services provided by a packet network voice platform;
directing voice packets to the first service provided by a packet network voice platform; and
directing voice packets from a second service of the plural services provided by a packet network voice platform independent of receiving packets for the first service.

12. The computer program product as claimed in claim 11, wherein the first service comprises a speech recognition service.

13. The computer program product as claimed in claim 11, wherein the first service comprises a record server.

14. The computer program product as claimed in claim 11, wherein the first service comprises a DTMF Collector.

15. The computer program product as claimed in claim 11, wherein the second service comprises a Text-to-Speech Server.

16. The computer program product as claimed in claim 11, wherein the second service comprises a Prompt Server.

17. The computer program product as claimed in claim 11, wherein the first and second services are implemented on a single machine.

18. The computer program product as claimed in claim 11, wherein the first service is implemented on a first machine and the second service is implemented on a second machine.

19. The computer program product as claimed in claim 18, further comprising the step of load balancing the first and second services between the first and second machines.

20. The computer program product as claimed in claim 11, wherein the first and second services are implemented on a single machine.
